(19) United States
(12) Patent Application Publication
(10) Pub. No.: US 2026/0267135 A1
(43) Pub. Date: Sep. 10, 2026

(54) SYSTEMS, MEDIA, AND METHODS FOR METAGRATING DEVELOPMENT

(71) Applicant: 3M INNOVATIVE PROPERTIES COMPANY, St. Paul, MN (US)

(72) Inventors: Jennifer F. Schumacher, Woodbury, MN (US); Cameron M. Fabbri, St. Paul, MN (US); Vahid Mirjalili, Ramsey, MN (US); Caitlin M. Race, Stillwater, MN (US); Yinong Wang, Woodbury, MN (US); Benjamin D. Zimmer, Hudson, WI (US)

(21) Appl. No.: 19/470,504

(22) PCT Filed: Mar. 14, 2024
(86) PCT No.: PCT/IB2024/052511

§ 371 Date: Sep. 29, 2025

Related U.S. Application Data
(60) Provisional application No. 63/493,719, filed on Mar. 31, 2023.

(51) Int. Cl. G02B 27/00; G06F 30/27; G06N 3/08

(52) U.S. Cl. CPC G02B 27/0012; G06F 30/27; G06N 3/08

(57) ABSTRACT

The disclosure provides a device including at least one non-transitory computer-readable storage medium having instructions stored thereon, and processing circuitry coupled to the at least one non-transitory computer-readable storage medium. The processing circuitry is configured to execute the instructions to provide randomized data to a neural network, receive a metagrating design from the neural network, generate, for each non-zero order in a plurality of non-zero orders, a diffraction performance value based on the metagrating design, determine a loss value based on the diffraction performance values associated with the plurality of non-zero orders, update the neural network based on the loss value, and output the neural network to at least one of an external device or the at least one non-transitory computer-readable storage medium.

### BACKGROUND

Electromagnetic metagratings, also known as metagratings, can modulate or otherwise influence behavior of electromagnetic waves via deeply sub-wavelength structures. For example, optical metagratings can modulate behavior of wavelengths in or near the visible spectrum of wavelengths. Certain applications such as augmented reality films, in-display fingerprint reader films, switchable privacy films, LIDAR, and/or anti-photography films can utilize optical metagratings.

### SUMMARY

In one embodiment, the disclosure provides a device including at least one non-transitory computer-readable storage medium having instructions stored thereon, and processing circuitry coupled to the at least one non-transitory computer-readable storage medium. The processing circuitry is configured to execute the instructions to provide randomized data to a neural network, receive a metagrating design from the neural network, generate, for each non-zero order in a plurality of non-zero orders, a diffraction performance value based on the metagrating design, determine a loss value based on the diffraction performance values associated with the plurality of non-zero orders, update the neural network based on the loss value, and output the neural network to at least one of an external device or the at least one non-transitory computer-readable storage medium.

In another embodiment, the disclosure provides a device including at least one non-transitory computer-readable storage medium having instructions stored thereon, and processing circuitry coupled to the at least one non-transitory computer-readable storage medium. The processing circuitry is configured to execute the instructions to provide randomized data to a neural network that is previously trained to generate a metagrating design by repeatedly providing randomized data to a neural network, receiving a metagrating design from the neural network, generating, for each non-zero order in a plurality of non-zero orders, a diffraction performance value based on the metagrating design, determining a loss value based on the diffraction performance values associated with the plurality of non-zero orders, and updating the neural network based on the loss value, receive a target metagrating design from the trained neural network, and output the target metagrating design to at least one of an external device or the at least one non-transitory computer-readable storage medium.

In yet another embodiment, the disclosure provides a device including at least one non-transitory computer-readable storage medium having instructions stored thereon, and processing circuitry coupled to at least one non-transitory computer-readable storage medium. The processing circuitry is configured to execute the instructions to provide randomized data to a neural network, receive a metagrating design from the neural network, the metagrating design comprising a plurality of one-dimensional features, determine a largest feature based on the plurality of features, shift the largest feature within the metagrating design, determine a loss value based on the metagrating design, update the neural network based on the loss value, and output the neural network to at least one of an external device or the at least one non-transitory computer-readable storage medium.

In still yet another embodiment, the disclosure provides a device including at least one non-transitory computer-readable storage medium having instructions stored thereon, and processing circuitry coupled to the at least one non-transitory computer-readable storage medium. The processing circuitry is configured to execute the instructions to provide randomized data to a neural network previously trained to generate a metagrating design by repeatedly providing randomized data to the neural network, receiving a metagrating design from the neural network, shifting the largest feature within the metagrating design, determining a loss value based on the metagrating design, and updating the neural network based on the loss value, receive a target metagrating design from the neural network, and output the target metagrating design to at least one of an external device or the at least one non-transitory computer-readable storage medium.

These and additional features provided by the embodiments described herein will be more fully understood in view of the following detailed description, in conjunction with the drawings.

### BRIEF DESCRIPTION OF THE DRAWINGS

FIG. 1 is a block diagram illustrating an exemplary system in which devices having communication capabilities are utilized and managed, according to aspects of this disclosure.

FIG. 2 is a block diagram illustrating an operating perspective of the system shown in FIG. 1.

FIG. 3 illustrates an exemplary metagrating according to aspects of this disclosure.

FIG. 4 illustrates an exemplary generative network according to aspects of this disclosure.

FIG. 5A illustrates an exemplary metagrating design with discontinuous features according to aspects of this disclosure.

FIG. 5B illustrates a concatenation of copies the metagrating design in FIG. 5A.

FIG. 5C illustrates an exemplary metagrating design including the discontinuous features of FIG. 5A aggregated to form a continuous feature according to aspects of this disclosure.

FIG. 6 illustrates an exemplary process for shifting features of a metagrating design according to aspects of this disclosure.

FIG. 7A illustrates an exemplary diagram of incident light at angle theta and corresponding reflection with an optical metagrating according to aspects of this disclosure.

FIG. 7B illustrates an exemplary diagram of incident light at angle theta and corresponding transmission with an optical metagrating according to aspects of this disclosure.

FIG. 8 illustrates an exemplary process for training a metagrating design generator using diffraction performance values according to aspects of this disclosure.

FIG. 9 illustrates an exemplary process for training a metagrating design generator using efficiency performance values according to aspects of this disclosure.

FIG. 10 illustrates an exemplary process for training a metagrating design generator using diffraction performance values and/or efficiency performance values according to aspects of this disclosure.

FIG. 11 illustrates an exemplary process for generating a metagrating design according to aspects of this disclosure.

### DETAILED DESCRIPTION

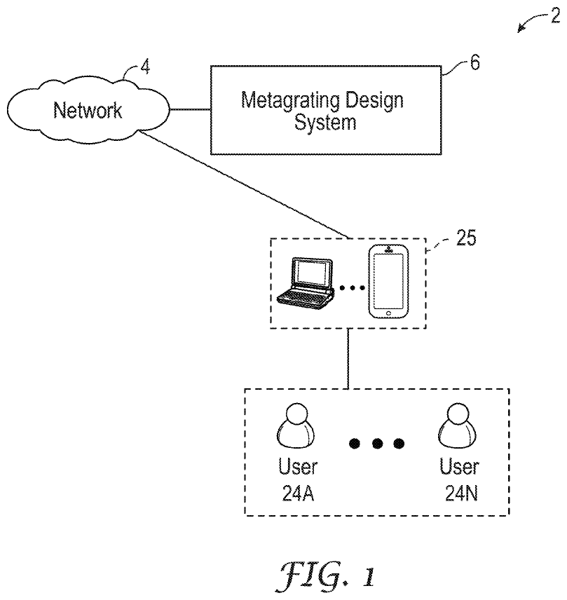

FIG. 1 is a block diagram illustrating an exemplary system 2 in which devices having communication capabilities are utilized and managed, according to aspects of this disclosure. System 2 includes metagrating design system (MDS) 6, which is configured to provide metagrating design functionalities to computing devices 25 in accordance with aspects of this disclosure. As described herein, MDS 6 enables authorized users (e.g., one of users 24A-24N) to generate metagrating designs. By interacting with MDS 6, design professionals can, for example, generate metagrating designs, train metagrating generators, and/or simulate metagrating designs. In general, MDS 6 provides design and simulation functionalities.

As shown in the example of FIG. 1, system 2 represents a computing environment in which a computing device (e.g., one of the computing devices 25) can electronically communicate with MDS 6 via one or more computer networks 4. The network 4 can include one or more wired and/or wireless connections. For example, the network 4 can include connections defined by the Institute of Electrical and Electronics Engineers (IEEE) 802.11 family of protocols, ZigBee® network connections (conforming to the IEEE 802.15 family of standards), 5G® network connections, short-range wireless (e.g., Bluetooth® and/or near-field communication (NFC)) connections, Ethernet® connections, and/or coaxial connections.

One or more of users 24A-24N may use computing devices 25 to interact with MDS 6 via network 4. For example, the end-user computing devices 25 may include, be, or be part of laptops, desktop computers, mobile devices such as tablet computers or so-called “smartphones,” and the like.

Users 24 (e.g., 24A-24N) interact with MDS 6 to generate metagrating designs, train metagrating generators and/or models, simulate metagrating designs, and/or utilize applications related to metagrating designs. For example, users 24 may generate a metagrating design to satisfy one or more design parameters. In addition, users 24 may interact with MDS 6 to simulate metagrating designs to gauge the performance of one or more metagrating designs. MDS 6 may enable users 24 to train a generator and/or model to create metagrating designs. In some examples, MDS 6 may present a web-based interface via a web server (e.g., an HTTP server) or client-side applications may be deployed for devices of computing devices 25 used by users 24, such as desktop computers, laptop computers, mobile devices such as smartphones or tablets, or the like.

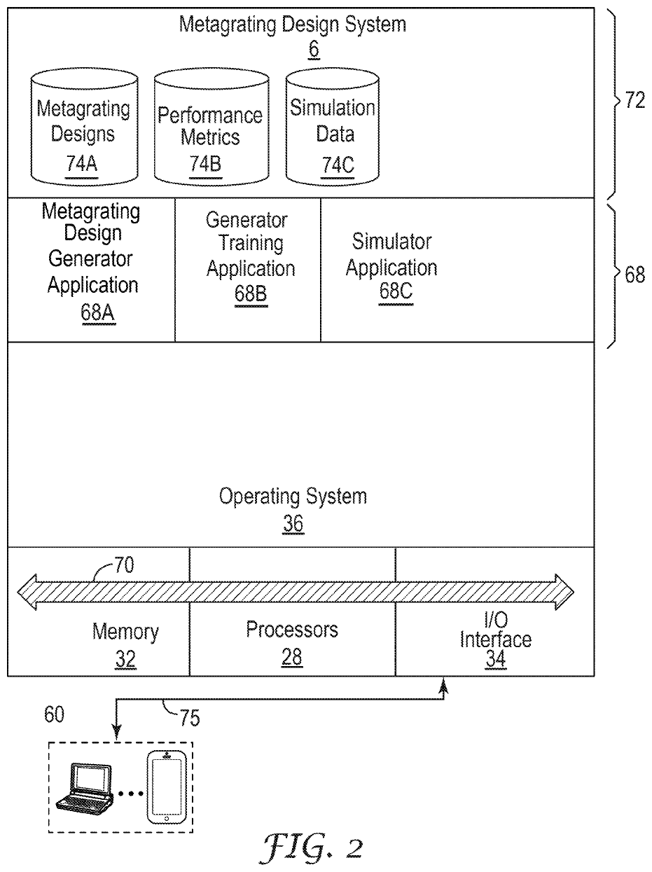

FIG. 2 is a block diagram illustrating an operating perspective of one example implementation of MDS 6 shown in FIG. 1. While FIG. 2 shows one implementation of MDS 6 that is consistent with aspects of this disclosure, it will be appreciated that other architectures (whether single-device or distributed architectures) of MDS 6 are consistent with aspects of this disclosure, as well.

In the example of FIG. 2, MDS 6 includes one or more processors 28 and memory 32. In some examples, memory 32 and processors 28 may be integrated into a single hardware unit, such as a system on a chip (SoC) or integrated circuit (IC). Each of processors 28 may comprise one or more of a multi-core processor, a controller, a digital signal processor (DSP), an application specific integrated circuit (ASIC), a field-programmable gate array (FPGA), processing circuitry (e.g., fixed function circuitry, programmable circuitry, or any combination of fixed function circuitry and programmable circuitry) or equivalent discrete logic circuitry or integrated logic circuitry. Memory 32 may include any form of memory for storing data and executable software instructions, such as random-access memory (RAM), read-only memory (ROM), programmable read only memory (PROM), erasable programmable read-only memory (EPROM), electronically erasable programmable read only memory (EEPROM), and flash memory.

Memory 32 and processor(s) 28 provide a computer platform for executing operation system 36. In turn, operating system 36 provides a multitasking operating environment for executing one or more software components 68. As shown, processors 28 connect via an input/output (I/O) interface 34 to external systems and devices, such as to interfaces deployed at computing devices 60, and the like. I/O interface 34 may incorporate network interface hardware, such as one or more wired and/or wireless network interface controllers (NICs) for communicating via communication channel 75, which may represent one or more network-enabled communicative connections, such as one or more packet-switched networks. Bus 70 provides inter-component connectivity between processors 28, memory 32, and I/O interface 34 in the implementation shown in FIG. 2. Bus 70 may represent a half-duplex or full-duplex bus that provides data transfer capabilities between two or more of processors 28, memory 32, I/O interface 34, and/or any other hardware components of MDS 6. Bus 70 may represent a system bus or a computer bus of various types, including one or more bus networks. Regardless of the topology implemented, bus 70 may, in various examples, incorporate various types of inter-component connectivity hardware such as those conforming to any of first generation, second generation, third generation, or fourth generation bus or bus network technology as set forth by the IEEE, and/or other bus or bus network technologies defined in developing or later-adopted standards.

Software components 68 of MDS 6, in the particular example of FIG. 2, include metagrating design generator application 68A, generator training application 68B, and simulator application 68C. In some example approaches, one or more of software components 68 represent executable software instructions that may take the form of one or more software applications, software packages, software libraries, hardware drivers, and/or Application Program Interfaces (APIs). Moreover, any of software components 68 may output data and/or receive data via I/O interface 34.

Aspects of memory 32 that provide non-volatile storage and/or long-term storage support local storage of data repositories 72. In the example of FIG. 2, data repositories 72 include metagrating designs 74A, performance metrics 74B, and simulation data 74C. One or more of software components 68 may invoke processors 28 and memory 32 to access one or more of data repositories 72 to retrieve data for various purposes, such as comparison, processing, and relaying, and/or viewing metagrating designs, performance metrics, and/or simulation data. In some examples, software components 68 may implement read/write capabilities with respect to data repositories 72, such as to access and use information available from data repositories 72 and/or to modify information currently stored to data repositories 72. In implementations in which MDS 6 represents a distributed computing system, one or more of data repositories 72 may be positioned at a remote location from processors 28, and software components 68 may, in these implementations, access data repositories 72 using NIC hardware of I/O interface 34.

Metagrating design generator application 68A operates as an application for generating metagrating designs using a generator and/or model (e.g., a machine learning model). In some examples, the metagrating design generator application 68A can also implement other processes related to metagrating generation, such as a feature shifting process. As will be described below, the metagrating design generator application 68A can generate metagrating designs for metagrating to be used in various applications (e.g., optical metagratings for augmented reality films, in-display fingerprint reader films, switchable privacy films, LIDAR, and/or anti-photography films). Generator training application 68B operates as an application for training machine learning models such as neural networks and/or generators to generate metagrating designs. In some examples, the generator training application 68B can also implement other processes related to metagrating generation, such as a feature shifting process. In some examples, the generator training application 68B can output trained generators and/or models to the metagrating design generator application 68A. The simulator application 68C operates as an application for simulating metagrating designs to generate performance metrics for a given metagrating design.

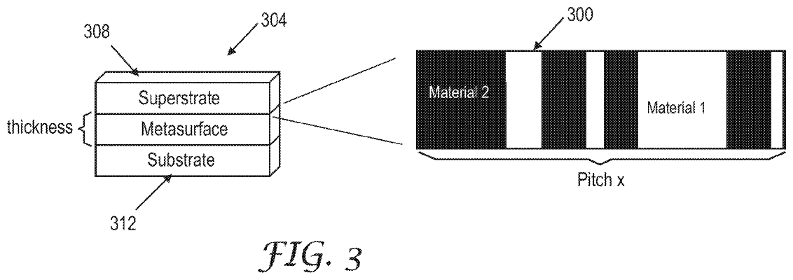

FIG. 3 illustrates an exemplary metagrating 300 according to aspects of this disclosure. As shown, the metagrating 300 is included in a metagrating device 304. The metagrating 300 can be arranged between a superstrate 308 and a substrate 312. In some examples, the metagrating 300 can be exposed to air on one or more sides, meaning the superstrate 308 and/or the substrate 312 can be air. In some examples, the superstrate 308 and/or the substrate 312 can include one or more solid materials such as a polymer (e.g., polyethylene terephthalate and/or polyvinyl butyral) and/or silica glass. In some examples, the superstrate 308 and/or the substrate 312 can be a uniform material having a predetermined thickness. In some examples, the superstrate 308 and/or the substrate 312 can include multiple layers of materials each having a predetermined thickness. In some examples, the superstrate 308 and/or the substrate 312 can be the same. The metagrating 300 can be of a predetermined thickness, and may include two materials arranged in a way that produces a desired effect (e.g., enhancing transmission efficiency for a certain wavelength and incident angle). Each material included in the metagrating 300 can extend throughout the entire thickness of the metagrating 300. While the metagrating 300 is a three-dimensional material, the materials may be arranged variably along an x-axis of the metagrating 300 without variation in how far the materials extend along a z-axis. Thus, the arrangement of the materials can be considered a one-dimensional problem, even though the thickness of the materials (and by extension, the metagrating 300) is also a factor in metagrating construction.

Physical characteristics of the metagrating device 304 can include refractive indices of materials included in the superstrate 308 and/or the substrate 312, dispersive refractive indices of the materials included in the metagrating 300, the thickness of the metagrating 300, and the pitch of the metagrating 300. In some examples, if a desired thickness and/or pitch for the metagrating 300 is unknown, thickness and/or pitch can be conditioned during training. In some examples, mirror symmetries of the structures included in the metagrating 300 can be defined as having symmetry about the x-axis or no symmetry. Metagrating designs that utilize symmetry can reduce computational time of training by up to about fifty percent.

Optical characteristics of the metagrating device 304 can include a position of a light source in relation to the superstrate 308 and/or the substrate 312, an optical mode (e.g., reflect, transmit, and/or absorb), a polarization (e.g., transverse electric, transverse magnetic, and/or unpolarized), an optical order (one order or multiple orders), one or more wavelengths, one or more polar angles, one or more azimuthal incident angles, and/or a desired optical efficiency. Generators of this disclosure may be trained to generate metagratings that satisfy one or more sets of specifications defining the optical characteristics. In some examples, certain optical characteristics (e.g., one or more diffraction angles) can be specified by a user, while other optical characteristics (e.g., a thickness value and/or a pitch value) may be generated by the generator. In this way, the generator can be conditioned to satisfy particular performance requirements set by a user. In some examples, the generator can generate feature information for one or more features included in the metagrating design. In some examples, for each feature, the feature information can include a material value and/or a location value. The material value can indicate a type of material and/or material characteristics (e.g., wavelength values, refractive index values, and/or other optical performance information). The location value can indicate a location of the feature along the pitch of the metagrating design.

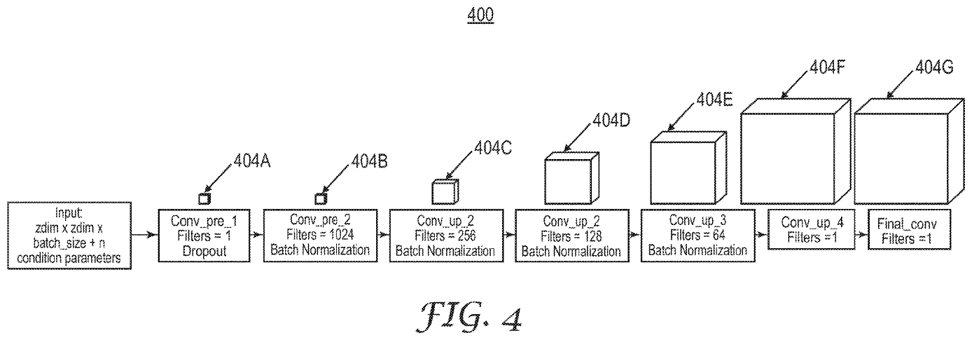

Referring now to FIG. 4, an exemplary generative network 400 according to aspects of this disclosure is shown. In some examples, the generative network 400 can be implemented as a generator and/or a portion of a generator. In some examples, the generative network 400 can be a neural network such as a convolutional neural network (CNN). The generative network 400 can include a number of convolutional layers 404A-G. The generative network 400 can include a number of Leaky ReLU activations. The generative network 400 can also include periodic padding on each of the convolutional layers 404A-G. The periodic padding can build periodicity into the generative network 400. The generative network 400 can generate metagratings used as tiles in one or more periodic surfaces, so building periodicity into the generative network 400 can improve performance in the generated metagratings. In some examples, the architecture of the generative network 400 can include various number of layers, filter sizes, and/or upscaling, and generator training application 68B can train the generative network 400 using various network hyperparameters such as learning rate, batch size, and/or number of steps.

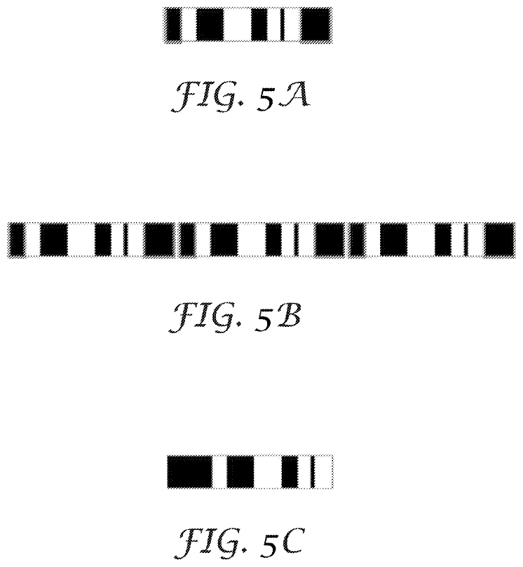

Referring now to FIGS. 5A, 5B, and 5C, FIG. 5A illustrates an exemplary metagrating design with discontinuous features according to aspects of this disclosure. FIG. 5B illustrates a concatenation of copies of the metagrating design in FIG. 5A. FIG. 5C illustrates an exemplary metagrating design including the discontinuous features of FIG. 5A aggregated to form a continuous feature according to aspects of this disclosure. In some examples, a generator may produce metagrating designs with discontinuous features. Without accounting for the discontinuous features, a generator may generate copies of the same metagrating designs, where the only difference between metagrating designs is the periodicity of the features, thereby suppressing metagrating diversity. By shifting discontinuous features to form continuous features, the periodicity of metagrating designs can be accounted for.

In some examples, a training process and/or generating process can include aggregating discontinuous features to form a largest possible feature. The process can include identifying a largest possible feature in a metagrating design, and then positioning the largest possible feature on a first end of the metagrating design. In some examples, the first end can be a left end of the metagrating design. To shift the largest feature to the first end of the metagrating design, the process can include generating two copies of a discontinuous featured surface (e.g., the metagrating design in FIG. 5A) and generating a concatenation of a first copy of the metagrating design, the metagrating design, and a second copy of the metagrating design. As shown, FIG. 5B illustrates a first copy of the metagrating design concatenated to a first end of the metagrating design, and a second copy of the metagrating design concatenated to a second end of the metagrating design. Thus, the process can include concatenating multiple copies of the discontinuous featured surface.

The process can include shifting the largest feature to the first end of the metagrating design. In this way, the periodicity of the metagrating design is accounted for, and the largest continuous feature is included continuously in the metagrating design. In some examples, the process can include detecting similar metagrating designs in a batch of metagrating designs after shifting the largest feature using an image similarity module. After detection, relatively similar images are all shifted to have the same representation with the largest feature at the beginning of the metagrating design. It is desirable to train a generator to generate diverse shapes rather than generate the same shapes having different periodicity. In some examples, the process can generate a cosine similarity value for pairs of metagrating designs, the cosine similarity value indicating a relative similarity between metagrating designs. The process can then evaluate cosine similarity values and/or penalize the generator based on the cosine similarity values.

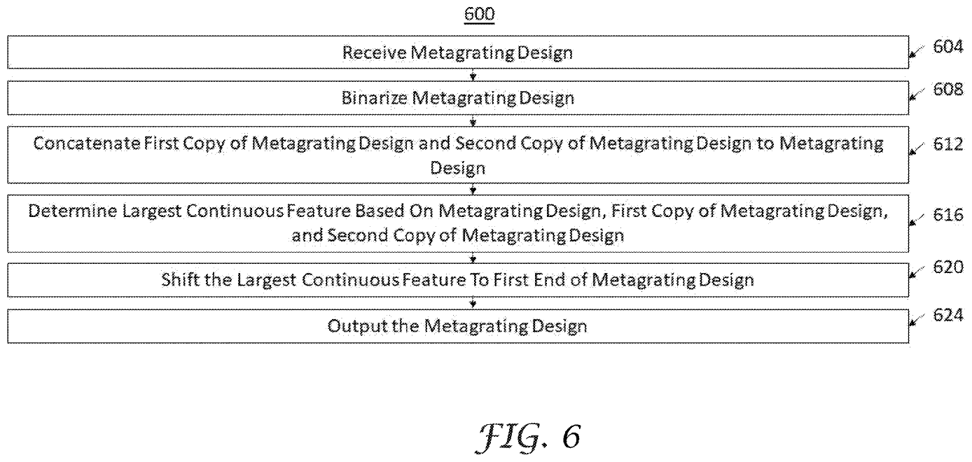

Referring now to FIGS. 5A, 5B, and 5C, as well as FIG. 6, an exemplary process 600 for shifting discontinuous features according to aspects of this disclosure is illustrated. In some examples, the process 600 can be implemented in the metagrating design generator application 68A and/or the generator training application 68B in FIG. 2. In some examples, the process 600 can be implemented as instructions on at least one non-transitory computer-readable storage medium (e.g., the memory 32 in FIG. 2) and executed by one or more processors (e.g., the processors 28) coupled to the at least one non-transitory computer-readable storage medium and configured to execute the instructions.

At 604, the process 600 can receive a metagrating design (e.g., the metagrating design in FIG. 5A). In some examples, the metagrating design can include a number of features arranged along an x-axis of the metagrating design. In some examples, the metagrating design can include feature information for one or more of the features included in the metagrating design. In some examples, for each feature, the feature information can include a material value and/or a location value. The material value can indicate a type of material and/or material characteristics (e.g., wavelength values, refractive index values, and/or other optical performance information). The location value can indicate a location of the feature along the pitch of the metagrating design. In some examples, each feature can be associated with a first material or a second material. In some examples, the metagrating design can include a thickness value (e.g., z-axis length) and/or a pitch value for width (e.g., x-axis length). The process 600 can then proceed to 608.

At 608, the process 600 can binarize the metagrating design. In some examples, at least a portion of the features included in the metagrating design may be associated with both the first material and the second material. For example, if the first material is represented by a value of zero, and the second material is represented by a value of one, the features may include values selected from a continuous range of zero to one. The process 600 can binarize each feature to either zero or one based on a predetermined threshold. The process 600 can then proceed to 612.

At 612, the process 600 can concatenate of a first copy of the metagrating design and a second copy of the metagrating design to the metagrating design. In some examples, the process 600 can concatenate the first copy of the metagrating design to a first end of the metagrating design and a second copy of the metagrating design to a second end of the metagrating design. The process 600 can then proceed to 616.

At 616, the process 600 can determine a largest continuous feature included in the concatenation of the first copy of the metagrating design, the second copy of the metagrating design, and the metagrating design. The process 600 can then proceed to 620.

At 620, the process 600 can shift the largest continuous feature to the first end of the metagrating design. In some examples, the process 600 can shift a first end of the largest continuous feature to the first end of the metagrating design, ensuring the entire continuous feature is included in the metagrating design. The process 600 can then proceed to 624.

At 624, the process 600 can output the metagrating design to at least one of a user interface, an external device, or at least one non-transitory computer-readable storage medium. The process 600 can then end.

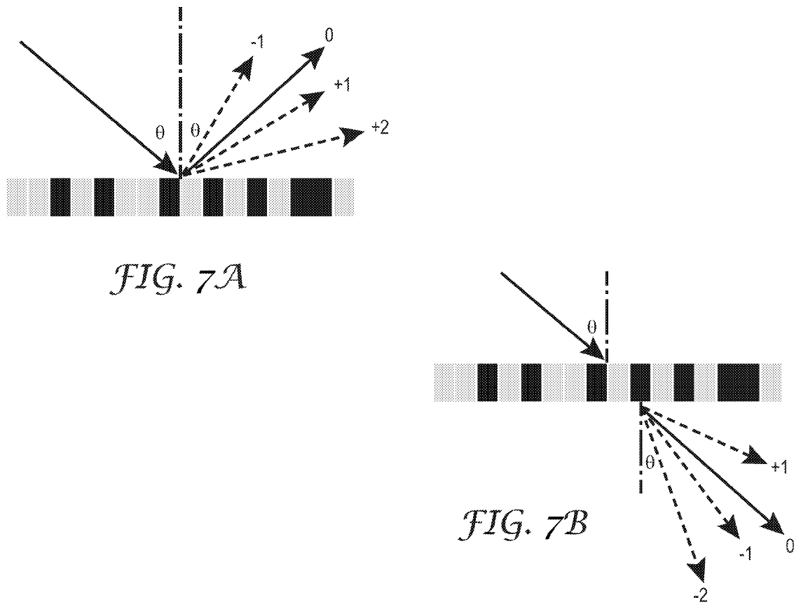

FIG. 7A illustrates an exemplary diagram of incident light at angle theta and corresponding reflection with an optical metagrating according to aspects of this disclosure. FIG. 7B illustrates an exemplary diagram of incident light at angle theta and corresponding transmission with an optical metagrating according to aspects of this disclosure.

FIGS. 7A and 7B illustrate multiple orders of refracted light and transmitted light, respectively. Optical films such as metagratings have diffraction characteristics as well as spectral response that needs to be appropriate for specific applications. In the case of a windshield combiner film, it is desirable to minimize any artifacts that would detract from the visual quality of the image. Light that reflects or transmits at an angle equal to the incoming angle (assuming approximately identical superstrate and substrate layers) is called specular or Oth order diffraction. Light that is diffracted at other angles are described as diffuse or non-zero diffraction orders and are labeled as +/−1, 2 in FIGS. 7A and 7B. Non-zero diffractions orders prevent preferrable specular reflection and transmission at particular wavelengths and angles while also causing perceptual artifacts like haze and rainbowing in optical films. Haze is the percentage of transmitted light, passing through a specimen, which deviates from the incident light by no more than 0.044 radians by forward scattering. Rainbowing is the response of a metagrating that is different at different wavelengths due to material dispersion, often measured from the non-zero order reflection and transmission. As will be described below, non-zero order diffraction light efficiencies can be estimated and used to generate a loss value in order to train a generator to generate metagrating designs that minimize efficiencies of non-zero diffraction orders. In some examples, non-zero order diffraction light efficiencies can be estimated and used to generate a loss value in order to train a generator to generate metagrating designs that maximize efficiencies of non-zero diffraction orders.

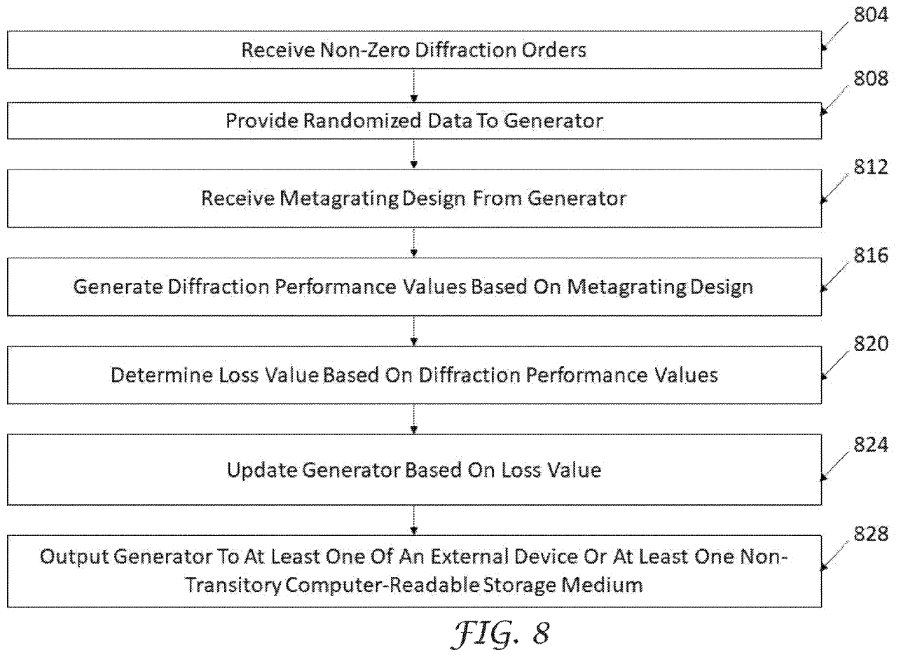

FIG. 8 illustrates an exemplary process 800 for training a metagrating design generator according to aspects of this disclosure. Specifically, the process 800 can train a generator to generate metagrating designs with improved spectral response. In some examples, the metagrating design can include a metagrating (e.g., the metagrating 300 in FIG. 3). In some examples, the metagrating design can include and/or be associated with a metagrating device and/or portions of the metagrating device (e.g., the metagrating device 304 in FIG. 3). In some examples, the metagrating design can include a superstrate (e.g., the superstrate 308 in FIG. 3) and a substrate (e.g., the substrate 312 in FIG. 3). In some examples, the metagrating device and/or portions of the metagrating device can be predetermined. In some examples, the metagrating can be exposed to air on one or more sides, meaning the superstrate and/or the substrate can be air. In some examples, the superstrate and/or the substrate can include one or more solid materials such as a polymer (e.g., polyethylene terephthalate and/or polyvinyl butyral) and/or silica glass. In some examples, the superstrate and/or the substrate can be a uniform material having a predetermined thickness. In some examples, the superstrate and/or the substrate can include multiple layers of materials each having a predetermined thickness. In some examples, the superstrate and/or the substrate can be the same. The metagrating can be of a predetermined thickness and can contain two materials arranged to produce a desired effect (e.g., enhancing transmission efficiency for a certain wavelength and incident angle). In some examples, the generator can be trained to output a metagrating design for a predetermined metagrating device (e.g., a predetermined substrate and superstrate). In some examples, the process 800 can be implemented in the generator training application 68B and/or the simulator application 68C in FIG. 2.

In some examples, the process 800 can be implemented as instructions on at least one non-transitory computer-readable storage medium (e.g., the memory 32 in FIG. 2) and executed by one or more processors (e.g., the processors 28) coupled to the at least one non-transitory computer-readable storage medium and configured to execute the instructions. In some examples, the process 800 can be executed to train a generator. In some examples, the generator can include a machine learning model such as a neural network (e.g., generative network 400 in FIG. 4).

At 804, the process 800 can receive one or more non-zero diffraction orders. In some examples, the one or more non-zero diffraction orders can be received from a user at a user interface. In some examples, the one or more non-zero diffraction orders can be selected by the user as orders of interest to either minimize or maximize.

In some examples, the process 800 can receive one or more physical parameter values. In some examples, the one or more physical parameter values can be referred to as one or more physical parameter values. The one or more physical parameter values can include one or more values and/or ranges that generated metagrating designs may be required to follow (e.g., specifications for a predetermined application). In some examples, the one or more physical parameter values can include a thickness value (e.g., z-axis length) and/or a pitch value for width (e.g., x-axis length). In some examples, the one or more physical parameter values can include a range of values for each of x-axis pitch and/or thickness. The process 800 can then proceed to 808.

At 808, the process 800 can provide randomized data to the generator. In some examples, the randomized data can be randomized noise. In some examples, the randomized data can be a random string of values formed into a one-dimensional input matrix. In some examples, the process 800 can receive a set of randomized data (e.g., a set of one hundred or more noise matrices) that can be used to train a generator. In some examples, the process 800 can also provide the physical parameter values to the generator. The process 800 can then proceed to 812.

At 812, the process 800 can receive a metagrating design from the generator. In some examples, the metagrating design can be the metagrating design 300 in FIG. 3. The metagrating design can include manufacturing data that allows a metagrating to be manufactured based on the metagrating design. Thus, the metagrating design can function as a blueprint for the metagrating. In some examples, the metagrating design can include an x-axis pitch value, a thickness value, materials information, and a mapping of one or more features. The mapping of one or more features can include location data (e.g., x coordinates) of one or more features in the metagrating. Each feature can be a continuous portion of a given material. For example, a metagrating including two materials may have ten features, with four features formed from a first material and six features formed from a second material. In some examples, the metagrating design can include a raster surface representation of a metagrating. In some examples, the process 800 can shift any discontinuous features in the metagrating design to create at least one larger feature. In some examples, the process 800 can perform at least a portion of the process 600 in FIG. 6. In some examples, the generator can include a metagrating design shifting module that executes at least a portion of the process 600 in FIG. 6, and may automatically shift features before outputting the metagrating design. The process 800 can then proceed to 816.

At 816, the process 800 can generate diffraction performance values based on the metagrating design. In some examples, each of the diffraction performance values can be associated with a wavelength and/or a source angle. In some examples, the diffraction performance values can include transmission values and/or reflection values. In some examples, each of the transmission values and/or reflection values can be a diffraction efficiency value associated with a polarization value. In some examples, the process 800 can provide the metagrating design to a simulator. In some examples, the simulator can be a physics-based simulator. In some examples, the process 800 can provide additional data to the simulator. In some examples, the process 800 can provide physical parameter values to the simulator. In some examples, the physical parameter values can include pitch values and/or thickness values. In some examples, the process 800 can scale the physical parameter values before providing the physical parameter values to the simulator. In some examples, the process 800 can provide the non-zero diffraction orders to the simulator. In some examples, the simulator can simulate desired optical characteristics (e.g., polarization and/or mode).

In some examples, the simulator can generate one or more performance metric values such as a reflection value and/or a transmission value for one or more wavelengths, angles, and/or orders. In some examples, the simulator can include a RCWA simulator such as RETICOLO or S4, and/or a FDTD simulator such as Lumerical or Meep. In some examples, the simulator can generate device gradients based on the metagrating design. In some examples, the device gradients can be associated with refractive index values of the surface of the metagrating design. The process 800 can then proceed to 820.

At 820, the process 800 can determine a loss value based on the diffraction performance values. In some examples, the process 800 can determine the loss value based on a sum of the diffraction performance values. In some examples, the process 800 can determine the loss value based on a loss function such as a Gaussian loss function and/or a softplus loss function. The process 800 can determine the loss value based on the sum of the diffraction performance values using the loss function. The process 800 can then proceed to 824.

At 824, the process 800 can update the generator based on the loss value. In some examples, the process 800 can proceed to 808 to continue training the generator if a condition has not been met (e.g., a predetermined number of training cycles has not been executed, a predetermined performance value has not been met, etc.). Otherwise, the process 800 can proceed to 828.

At 828, the process 800 can output the generator to at least one of an external device and/or at least one non-transitory computer-readable storage medium. The process 800 can then end.

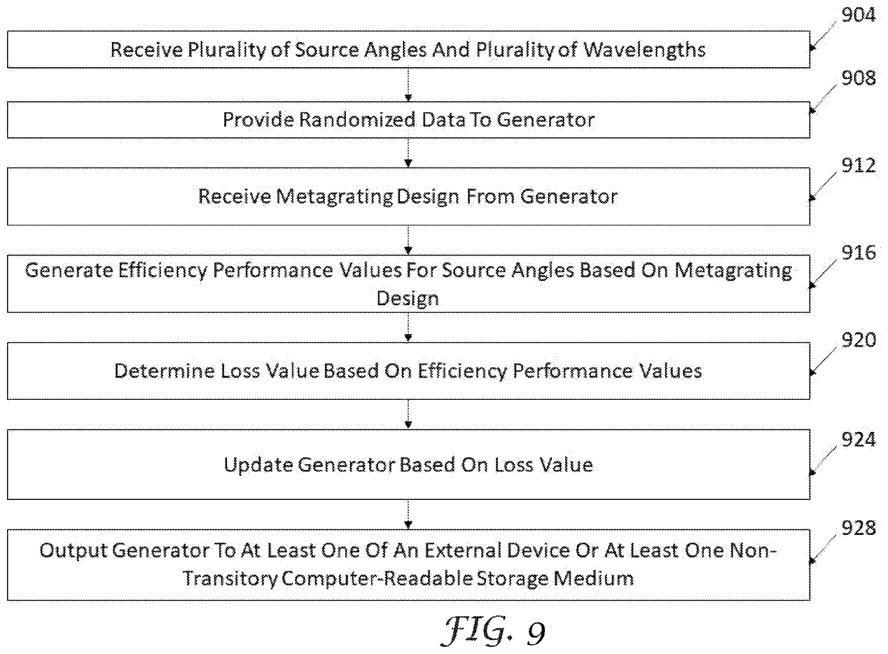

Referring now to FIG. 9, a process 900 for training a metagrating design generator to generate metagrating designs with reduced color shift is shown. Color shift is the phenomenon where the perceived color of a metagrating film changes and can be measured in L*a*b* color space as a function of the viewing angle. In electromagnetic simulation software relying on the RCWA method, it is not possible to simulate color shift due to the change in viewing angle. Thus, variation in source angle can be emulated to generate color shift simulation data. The presence or absence of color shift can be predicted from the heatmaps displaying diffraction efficiencies as a function of source angle and incident wavelength. Heatmap plots for a device with high color shift contain oriented gradients that can show changes in diffraction efficiencies as the source angle varies while the wavelength is fixed. Therefore, in order to estimate the color shift, it is possible to use variation in diffraction efficiencies as the source angle varies.

In order to penalize color shift, a term can be added to a loss function. Following the electromagnetic simulation of a generated metagrating design, variance of the transmission and reflection efficiencies for the orders of interest for a given wavelength (randomly sampled within a designated range of wavelengths of interest) can be calculated across the designated source angles. This term is then added to the loss function, training the generator to create metagrating designs with reduced color shift while also improving the defined transmission and reflection specifications for overall metagrating device performance.

FIG. 9 illustrates an exemplary process 900 for training a metagrating design generator according to aspects of this disclosure. Specifically, the process 900 can train a generator to generate metagrating designs with minimal color shift. In some examples, the metagrating design can include a metagrating (e.g., the metagrating 300 in FIG. 3). In some examples, the metagrating design can include and/or be associated with a metagrating device and/or portions of the metagrating device (e.g., the metagrating device 304 in FIG. 3). In some examples, the metagrating design can include a superstrate (e.g., the superstrate 308 in FIG. 3) and a substrate (e.g., the substrate 312 in FIG. 3). In some examples, the metagrating device and/or portions of the metagrating device can be predetermined. In some examples, the metagrating can be exposed to air on one or more sides, meaning the superstrate and/or the substrate can be air. In some examples, the superstrate and/or the substrate can include one or more solid materials such as a polymer (e.g., polyethylene terephthalate and/or polyvinyl butyral) and/or silica glass. In some examples, the superstrate and/or the substrate can be a uniform material having a predetermined thickness. In some examples, the superstrate and/or the substrate can include multiple layers of materials each having a predetermined thickness. In some examples, the superstrate and/or the substrate can be the same. The metagrating can be of a predetermined thickness and can contain two materials arranged to produce a desired effect (e.g., enhancing transmission efficiency for a certain wavelength and incident angle). In some examples, the generator can be trained to output a metagrating design for a predetermined metagrating device (e.g., a predetermined substrate and superstrate). In some examples, the process 900 can be implemented in the generator training application 68B and/or the simulator application 68C in FIG. 2.

In some examples, the process 900 can be implemented as instructions on at least one non-transitory computer-readable storage medium (e.g., the memory 32 in FIG. 2) and executed by one or more processors (e.g., the processors 28) coupled to the at least one non-transitory computer-readable storage medium and configured to execute the instructions. In some examples, the process 900 can be executed to train a generator. In some examples, the generator can include a machine learning model such as a neural network (e.g., generative network 400 in FIG. 4).

At 904, the process 900 can receive a plurality of source angles and a plurality of wavelengths. In some examples, the plurality of source angles and a plurality of wavelengths can be received from a user at a user interface. In some examples, the plurality of source angles and a plurality of wavelengths can be selected by the user as orders of interest to either minimize or maximize.

In some examples, the process 900 can receive one or more physical parameter values. In some examples, the one or more physical parameter values can be referred to as one or more physical parameter values. The one or more physical parameter values can include one or more values and/or ranges that generated metagrating designs may be required to follow (e.g., specifications for a predetermined application). In some examples, the one or more physical parameter values can include a thickness value (e.g., z-axis length) and/or a pitch value for width (e.g., x-axis length). In some examples, the one or more physical parameter values can include a range of values for each of x-axis pitch and/or thickness. The process 900 can then proceed to 908.

At 908, the process 900 can provide randomized data to the generator. In some examples, the randomized data can be randomized noise. In some examples, the randomized data can be a random string of values formed into a one-dimensional input matrix. In some examples, the process 900 can receive a set of randomized data (e.g., a set of one hundred or more noise matrices) that can be used to train a generator. In some examples, the process 900 can also provide the physical parameter values to the generator. The process 900 can then proceed to 912.

At 912, the process 900 can receive a metagrating design from the generator. In some examples, the metagrating design can be the metagrating design 300 in FIG. 3. The metagrating design can include manufacturing data that allows a metagrating to be manufactured based on the metagrating design. Thus, the metagrating design can function as a blueprint for the metagrating. In some examples, the metagrating design can include an x-axis pitch value, a thickness value, materials information, and a mapping of one or more features. The mapping of one or more features can include location data (e.g., x coordinates) of one or more features in the metagrating. Each feature can be a continuous portion of a given material. For example, a metagrating including two materials may have ten features, with four features formed from a first material and six features formed from a second material. In some examples, the metagrating design can include feature information for each feature included in the metagrating design. In some examples, for each feature, the feature information can include a material value and/or a location value. The material value can indicate a type of material and/or material characteristics (e.g., wavelength values, refractive index values, and/or other optical performance information). The location value can indicate a location of the feature along the pitch of the metagrating design. In some examples, each feature can be associated with a first material or a second material. In some examples, the metagrating design can include a raster surface representation of a metagrating. In some examples, the process 900 can shift any discontinuous features in the metagrating design to create at least one larger feature. In some examples, the process 900 can perform at least a portion of the process 600 in FIG. 6. In some examples, the generator can include a metagrating design shifting module that executes at least a portion of the process 600 in FIG. 6, and may automatically shift features before outputting the metagrating design. The process 900 can then proceed to 916.

At 916, the process 900 can generate efficiency performance values based on the metagrating design. In some examples, each of the efficiency performance values can be associated with a wavelength and/or a source angle included in the plurality of source angles and a plurality of wavelengths. In some examples, the efficiency performance values can include transmission values and/or reflection values. In some examples, the efficiency performance values can be diffraction efficiency values. In some examples, each of the source angles included in the plurality of source angles can be associated with a transmission value and a reflection value. In some examples, the process 900 can provide the metagrating design to a simulator. In some examples, the simulator can be a physics-based simulator. In some examples, the process 900 can provide additional data to the simulator. In some examples, the process 900 can provide physical parameter values to the simulator. In some examples, the physical parameter values can include pitch values and/or thickness values. In some examples, the process 900 can scale the physical parameter values before providing the physical parameter values to the simulator. In some examples, the simulator can simulate desired optical characteristics (e.g., polarization and/or mode).

In some examples, the simulator can generate one or more performance metric values such as a reflection value and/or a transmission value for one or more wavelengths, angles, and/or orders. In some examples, the simulator can include a RCWA simulator such as RETICOLO or S4, and/or a FDTD simulator such as Lumerical or Meep. In some examples, the simulator can generate device gradients based on the metagrating design. In some examples, the device gradients can be associated with refractive index values of the surface of the metagrating design. The process 900 can then proceed to 920.

At 920, the process 900 can determine a loss value based on the efficiency performance values. In some examples, the process 900 can determine the loss value based on a variance of the efficiency performance values. In some examples, the process 900 can determine the loss value based on a loss function such as a softplus loss function. The process 900 can determine the loss value based on the variance of the efficiency performance values using the loss function. The process 900 can then proceed to 924.

At 924, the process 900 can update the generator based on the loss value. In some examples, the process 900 can proceed to 908 to continue training the generator if a condition has not been met (e.g., a predetermined number of training cycles has not been executed, a predetermined performance value has not been met, etc.). Otherwise, the process 900 can proceed to 928.

At 928, the process 900 can output the generator to at least one of an external device and/or at least one non-transitory computer-readable storage medium. The process 900 can then end.

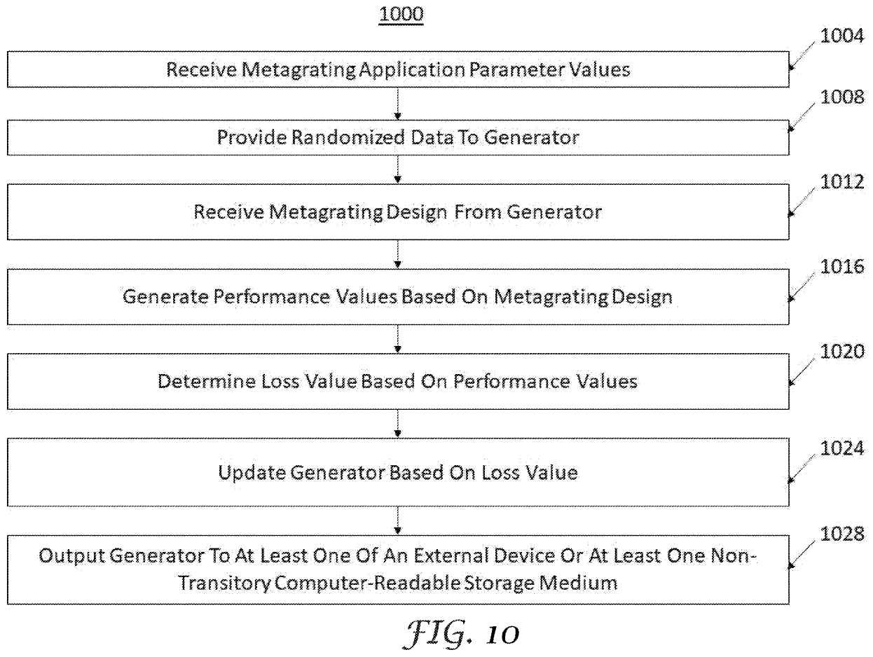

FIG. 10 illustrates an exemplary process 1000 for training a metagrating design generator according to aspects of this disclosure. Specifically, the process 1000 can train a generator to generate metagrating designs with improved spectral response minimal color shift. In some examples, the metagrating design can include a metagrating (e.g., the metagrating 300 in FIG. 3). In some examples, the metagrating design can include and/or be associated with a metagrating device and/or portions of the metagrating device (e.g., the metagrating device 304 in FIG. 3). In some examples, the metagrating design can include a superstrate (e.g., the superstrate 308 in FIG. 3) and a substrate (e.g., the substrate 312 in FIG. 3). In some examples, the metagrating device and/or portions of the metagrating device can be predetermined. In some examples, the metagrating can be exposed to air on one or more sides, meaning the superstrate and/or the substrate can be air. In some examples, the superstrate and/or the substrate can include one or more solid materials such as a polymer (e.g., polyethylene terephthalate and/or polyvinyl butyral) and/or silica glass. In some examples, the superstrate and/or the substrate can be a uniform material having a predetermined thickness. In some examples, the superstrate and/or the substrate can include multiple layers of materials each having a predetermined thickness. In some examples, the superstrate and/or the substrate can be the same. The metagrating can be of a predetermined thickness and can contain two materials arranged to produce a desired effect (e.g., enhancing transmission efficiency for a certain wavelength and incident angle). In some examples, the generator can be trained to output a metagrating design for a predetermined metagrating device (e.g., a predetermined substrate and superstrate). In some examples, the process 1000 can be implemented in the generator training application 68B and/or the simulator application 68C in FIG. 2.

In some examples, the process 1000 can be implemented as instructions on at least one non-transitory computer-readable storage medium (e.g., the memory 32 in FIG. 2) and executed by one or more processors (e.g., the processors 28) coupled to the at least one non-transitory computer-readable storage medium and configured to execute the instructions. In some examples, the process 1000 can be executed to train a generator. In some examples, the generator can include a machine learning model such as a neural network (e.g., generative network 400 in FIG. 4).

At 1004, the process 1000 can receive a plurality of metagrating application parameter values. In some examples, the plurality of metagrating application parameter values can include one or more non-zero diffraction orders as received at 804 in FIG. 8 and the plurality of source angles and a plurality of wavelengths received at 904 in FIG. 9. In some examples, the process 1000 can receive one or more physical parameter values as described at 804 in FIGS. 8 and/or 904 in FIG. 9. The one or more physical parameter values can be included in the plurality of metagrating application parameter values. The process 1000 can then proceed to 1008.

At 1008, the process 1000 can provide randomized data to the generator. In some examples, the randomized data can be randomized noise as described at 808 in FIGS. 8 and/or 908 in FIG. 9. In some examples, the process 1000 can also provide the physical parameter values to the generator. The process 1000 can then proceed to 1012.

At 1012, the process 1000 can receive a metagrating design from the generator. In some examples, the metagrating design can be the metagrating design 300 in FIG. 3. The metagrating design can include manufacturing data that allows a metagrating to be manufactured based on the metagrating design. Thus, the metagrating design can function as a blueprint for the metagrating. In some examples, the metagrating design can include an x-axis pitch value, a thickness value, materials information, and a mapping of one or more features. The mapping of one or more features can include location data (e.g., x coordinates) of one or more features in the metagrating. Each feature can be a continuous portion of a given material. For example, a metagrating including two materials may have ten features, with four features formed from a first material and six features formed from a second material. In some examples, the metagrating design can include feature information for each feature included in the metagrating design. In some examples, for each feature, the feature information can include a material value and/or a location value. The material value can indicate a type of material and/or material characteristics (e.g., wavelength values, refractive index values, and/or other optical performance information). The location value can indicate a location of the feature along the pitch of the metagrating design. In some examples, each feature can be associated with a first material or a second material. In some examples, the metagrating design can include a raster surface representation of a metagrating. In some examples, the process 1000 can shift any discontinuous features in the metagrating design to create at least one larger feature. In some examples, the process 1000 can perform at least a portion of the process 600 in FIG. 6. In some examples, the generator can include a metagrating design shifting module that executes at least a portion of the process 600 in FIG. 6, and may automatically shift features before outputting the metagrating design. The process 1000 can then proceed to 1016.

At 1016, the process 1000 can generate performance values based on the metagrating design. In some examples, the performance values can include the diffraction performance values as described at 816 in FIG. 8 and the efficiency performance values 916 in FIG. 9. The process 1000 can then proceed to 1020.

At 1020, the process 1000 can determine a loss value based on the performance values. In some examples, the loss value can be a final loss value determined based on a loss value determined based on the efficiency performance values diffraction performance values as described at 816 in FIG. 8 and a loss value determined based on the efficiency performance values 916 in FIG. 9. The process 1000 can then proceed to 1024.

At 1024, the process 1000 can update the generator based on the loss value. In some examples, the process 1000 can proceed to 1008 to continue training the generator if a condition has not been met (e.g., a predetermined number of training cycles has not been executed, a predetermined performance value has not been met, etc.). Otherwise, the process 1000 can proceed to 1028.

At 1028, the process 1000 can output the generator to at least one of an external device and/or at least one non-transitory computer-readable storage medium. The process 1000 can then end.

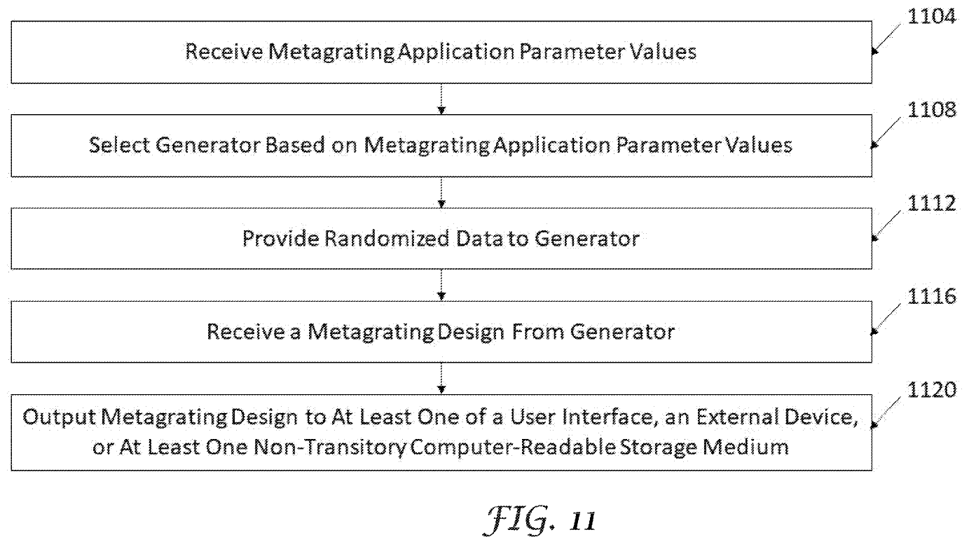

FIG. 11 illustrates an exemplary process 1100 for generating a metagrating design according to aspects of this disclosure. Specifically, the process 1100 can generate metagrating designs that can be manufactured for various metagrating devices. In some examples, the metagrating design can include a metagrating (e.g., the metagrating 300 in FIG. 3). In some examples, the metagrating design can include and/or be associated a metagrating device and/or portions of the metagrating device (e.g., the metagrating device 304 in FIG. 3). In some examples, the metagrating design can include a superstrate (e.g., the superstrate 308 in FIG. 3) and a substrate (e.g., the substrate 312 in FIG. 3). In some examples, the metagrating device and/or portions of the metagrating device can be predetermined. In some examples, the metagrating can be exposed to air on one or more sides, meaning the superstrate and/or the substrate can be air. In some examples, the superstrate and/or the substrate can include one or more solid materials such as a polymer (e.g., polyethylene terephthalate and/or polyvinyl butyral) and/or silica glass. In some examples, the superstrate and/or the substrate can be a uniform material having a predetermined thickness. In some examples, the superstrate and/or the substrate can include multiple layers of materials each having a predetermined thickness. In some examples, the superstrate and/or the substrate can be the same. The metagrating can be a predetermined thickness and contains two materials arranged to produce a desired effect (e.g., enhancing transmission efficiency for a certain wavelength and incident angle). In some examples, the generator can be trained to output a metagrating design for a predetermined metagrating device (e.g., a predetermined substrate and superstrate). In some examples, the process 1100 can be implemented in the metagrating design generator application 68A, the generator training application 68B, and/or the simulator application 68C in FIG. 2.

In some examples, the process 1100 can be implemented as instructions on at least one non-transitory computer-readable storage medium (e.g., the memory 32 in FIG. 2) and executed by one or more processors (e.g., the processors 28) coupled to the at least one non-transitory computer-readable storage medium and configured to execute the instructions.

At 1104, the process 1100 can receive one or more metagrating application parameter values. In some examples, the one or more metagrating application parameter values can be selected by a user. In some examples, the one or more metagrating application parameter values can include one or more physical parameter values and/or performance parameter values. In some examples, the one or more physical parameter values can be the physical parameter values 408 in FIG. 4. In some examples, the one or more physical parameter values can be referred to as one or more physical parameter values. The one or more physical parameter values can include one or more values and/or ranges that generated metagrating designs may be required to follow (e.g., specifications for a predetermined application). In some examples, the one or more physical parameter values can include physical parameter values such as thickness values (e.g., Z-axis length) and/or pitch values for width (e.g., x-axis length). In some examples, the one or more physical parameter values can include a range of values for each of x-axis pitch and thickness.

In some examples, the performance parameter values can include one or more of the user-defined metagrating specifications 416 in FIG. 4. The performance parameter values can be selected (e.g., by the user) in order to train the generator to produce metagrating designs having desirable performance qualities. In some examples, the performance parameter values can include a reflection value, a transmission value, and/or an absorption value for one or more wavelengths, angles, and/or orders. In some examples, the performance parameter values can be generated using Equation 2 and/or Equation 3 described above. The process 1100 can then proceed to 1108.

At 1108, the process 1100 can select a generator based on the one or more metagrating application parameter values. In some examples, the process 1100 can select a trained generator that satisfies each of the one or more metagrating application parameter values. In some examples, the process 1100 can select the generator from a database of pretrained generators. In some examples, the process 1100 can train a generator to generate metagrating designs that satisfy each of the one or more metagrating application parameter values. In some examples, the process 1100 can execute at least a portion of the process 800 in FIG. 8, the process 900 in FIG. 9, and/or the process 1000 in FIG. 10 in order to train a generator using the one or more metagrating application parameter values. Once the generator has been selected and/or trained, the process 1100 can proceed to 1112.

At 1112, the process 1100 can provide randomized data to the generator. In some examples, the process 1100 can receive the randomized data from a user and/or database. In some examples, the randomized data can be randomized noise. In some examples, the randomized data can be a random string of values formed into a one-dimensional input matrix. The process 1100 can then proceed to 1116.

At 1116, the process 1100 can receive a metagrating design from the generator. In some examples, the metagrating design can be the metagrating design 304 in FIG. 4. The metagrating design can include manufacturing data that allows a metagrating to be manufactured based on the metagrating design. Thus, the metagrating design can function as a blueprint for the metagrating. In some examples, the metagrating design can include an x-axis pitch value, a thickness value, materials information, and a mapping of one or more features. The mapping of one or more features can include location data (e.g., x and y coordinates) of one or more features in the metagrating. Each feature can be a continuous portion of a given material. For example, a metagrating including two materials may have ten features, with four features formed from a first material and six features formed from a second material. In some examples, the metagrating design can include a raster surface representation of a metagrating.

In some examples, the process 1100 can shift any discontinuous features in the metagrating design to create at least one larger feature. In some examples, the process 1100 can perform at least a portion of the process 600 in FIG. 6. The process 1100 can then proceed to 1120.

At 1120, the process 1100 can output the metagrating design to at least one of a user interface, an external device, or the at least one non-transitory computer-readable storage medium. The process 1100 can then end.

In the present detailed description of the example embodiments, reference is made to the accompanying drawings, which illustrate specific embodiments in which the invention may be practiced. The illustrated embodiments are not intended to be exhaustive of all embodiments according to the invention. It is to be understood that other embodiments may be utilized, and structural or logical changes may be made without departing from the scope of the present invention. The following detailed description, therefore, is not to be taken in a limiting sense, and the scope of the present invention is defined by the appended claims.

Unless otherwise indicated, all numbers expressing feature sizes, amounts, and physical properties used in the specification and claims are to be understood as being modified in all instances by the term “about” or “approximately” or “substantially.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

It is to be recognized that depending on the example, certain acts or events of any of the methods described herein can be performed in a different sequence, may be added, merged, or left out altogether (e.g., not all described acts or events are necessary for the practice of the method). Moreover, in certain examples, acts or events may be performed concurrently, e.g., through multi-threaded processing, interrupt processing, or multiple processors, rather than sequentially.

The techniques described in this disclosure may be implemented, at least in part, in hardware, software, firmware or any combination thereof. For example, various aspects of the described techniques may be implemented within one or more processors, including one or more microprocessors, CPUs, GPUs, DSPs, application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry (e.g., fixed function circuitry, programmable circuitry, or any combination of fixed function circuitry and programmable circuitry), alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in a computer-readable medium, such as a computer-readable storage medium, containing instructions. Instructions embedded or encoded in a computer-readable storage medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

Various examples have been described. These and other examples are within the scope of the following claims.

1. A device comprising:
at least one non-transitory computer-readable storage medium having instructions stored thereon;
and processing circuitry coupled to the at least one non-transitory computer-readable storage medium, the processing circuitry being configured to execute the instructions to:
provide randomized data to a neural network;
receive a metagrating design from the neural network;
generate, for each non-zero order in a plurality of non-zero orders, a diffraction performance value based on the metagrating design;
determine a loss value based on the diffraction performance values associated with the plurality of non-zero orders;
update the neural network based on the loss value; and
output the neural network to at least one of an external device or the at least one non-transitory computer-readable storage medium.

2. The device of claim 1, wherein the generating the diffraction performance value for each non-zero order in the plurality of non-zero orders comprises:
providing the metagrating design to a simulator; and
receiving the diffraction performance value associated with each non-zero order in the plurality of non-zero orders from the simulator.

3. The device of claim 1, wherein the determining the loss value comprises:
calculating a sum of the diffraction performance values associated with the plurality of non-zero orders; and
determining the loss value based on the sum of the diffraction performance values using a loss function.

4. The device of claim 3, wherein the loss function is a Gaussian loss function.

5. The device of claim 3, wherein the loss function is a softplus loss function.

6. The device of claim 1, wherein the diffraction performance values are diffraction efficiency values.

7. The device of claim 1, wherein each of the diffraction performance values associated with the plurality of non-zero orders is further associated with a predetermined wavelength.

8. The device of claim 1, wherein each of the diffraction performance values associated with the plurality of non-zero orders is further associated with a predetermined angle.

9. The device of claim 1, wherein the metagrating design comprises feature information associated with at least one feature included in the metagrating design, a pitch value, and a thickness value.

10. The device of claim 9, wherein the feature information comprises, for each feature included in the metagrating design, a material value and a location value.

11. The device of claim 1, wherein the diffraction performance values comprise at least one of transmission values or reflection values.

12. The device of claim 11, wherein each of the at least one of transmission values or reflection values is a diffraction efficiency value associated with a polarization value.

13. The device of claim 1, wherein the metagrating design is an optical film design.

14. The device of claim 1, wherein the processing circuitry is configured to further execute the instructions to:
generate a plurality of efficiency performance values based on the metagrating design, each efficiency performance value included in the plurality of efficiency performance values being associated with a source angle included in a plurality of predetermined source angles;
determine a second loss value based on the plurality of efficiency performance values; and
further update the neural network based on the second loss value.

15. The device of claim 14, wherein each efficiency performance value included in the plurality of efficiency performance values is further associated with a wavelength included in a plurality of predetermined wavelengths.

16. The device of claim 15, wherein the processing circuitry is configured to further execute the instructions to:
receive the plurality of predetermined wavelengths from a user interface.

17. The device of claim 14, wherein the processing circuitry is configured to further execute the instructions to:
receive the plurality of predetermined source angles from a user interface.

18. The device of claim 14, wherein the plurality of efficiency performance values comprises transmission efficiency performance values.

19. The device of claim 14, wherein the plurality of efficiency performance values comprises reflection efficiency performance values.

20. The device of claim 14, wherein the plurality of efficiency performance values comprises a plurality of reflection efficiency performance values and a plurality of transmission efficiency performance values, each source angle included in the plurality of predetermined source angles being associated with at least one reflection efficiency performance value included in the plurality of reflection efficiency performance values and at least one transmission efficiency performance value included in the plurality of transmission efficiency performance values.

21. The device of claim 20, wherein each efficiency performance value included in the plurality of efficiency performance values is further associated with a wavelength included in a plurality of predetermined wavelengths, each wavelength included in the plurality of predetermined wavelengths being associated with at least one reflection efficiency performance value included in the plurality of reflection efficiency performance values and at least one transmission efficiency performance value included in the plurality of transmission efficiency performance values.

22-37. (canceled)
